(19) United States
(12) Patent Application Publication
(10) Pub. No.: US 2026/0178406 A1
(43) Pub. Date: Jun. 25, 2026

(54) DYNAMIC MODALITY-SPECIFIC RESOURCE ALLOCATION IN MODEL-AS-A-SERVICE PLATFORM

(71) Applicant: Microsoft Technology Licensing, LLC, Redmond, WA (US)

(72) Inventors: Sanjay RAMANUJAN, Sammamish, WA (US); Fnu SIDHARTHA, Redmond, WA (US); Rakesh KELKAR, Bellevue, WA (US); Nitin GOYAL, Bothell, WA (US); Christopher Hakan BASOGLU, Everett, WA (US)

(21) Appl. No.: 18/989,903

(22) Filed: Dec. 20, 2024

(51) Int. Cl. G06F 9/50

(52) U.S. Cl. CPC G06F 9/505

(57) ABSTRACT

A model-as-a-service (MaaS) platform includes a multimodal model instance that is executed by dedicated groups of processing resources allocated to support different modality-specific processing pipelines. The MaaS platform further includes an intelligence layer that tracks modality-specific token utilization over time; generates a modality-specific workload prediction for the multimodal model instance based on the tracked data; and generates a modality-specific latency prediction based on the modality-specific workload prediction. The MaaS platform further includes a resource allocation component that uses the modality-specific latency prediction to dynamically reallocate the processing resources among the dedicated groups supporting the different modality-specific processing pipelines.

### BACKGROUND

A Model as a Service (MaaS) platform is a cloud-based artificial intelligence (AI) platform that provides developers and businesses with access to pre-built machine learning models accessible via application programming interface (API) calls governed by a responsible AI layer. These models can be designed to perform a wide range of AI tasks, such as natural language processing (NLP) tasks, computer vision tasks, speech recognition tasks, sentiment analysis tasks, recommendation systems, and anomaly detection.

In recent years, multimodal models have become increasingly important tools for processing and understanding diverse data types. A multimodal model is an artificial intelligence (AI) system designed to process and, in many cases, integrate information from multiple types (or “modes”) of data, such as text, images, audio, video, or other sensory inputs, to perform a task or generate an output. The ability to work with multiple modalities allows these models to understand complex data patterns and make more nuanced inferences that allow for personalization in the output.

Within MaaS platforms that offer multimodal models as services to end customers, challenges arise in relation to efficiently and adequately allocating computational resources to different model instances. Within these models, data of different modalities is processed in the form of tokens. However, tokens that embed data of different modalities have different processing demands. For example, more computational power is needed to process a token that embeds video data than a token that encodes natural language text. Consequently, the computational power needed to support a given instance of a multimodal model is highly dependent upon how end customers are using the instance—that is, what types of modalities those customers are processing and the relative quantities of tokens being processed for each different modality within each individual request.

### SUMMARY

According to one implementation, a model-as-a-service (MaaS) platform provides a multimodal model instance instantiated in hardware that includes dedicated groups of processing resources allocated to support different modality-specific processing pipelines of the multimodal model instance. The MaaS platform includes an intelligence layer that tracks modality-specific token utilization over time; generates a modality-specific workload prediction for the multimodal model instance based on the tracked data; and generates a modality-specific latency prediction based on the modality-specific workload prediction. The MaaS platform further includes a resource allocation component that uses the modality-specific latency prediction as a basis for dynamically reallocating the processing resources among the dedicated groups supporting the different modality-specific processing pipelines.

According to another implementation, the intelligence layer of the MaaS platform intelligence layer uses tracked token utilization data for a select customer to generate a predicted token ensemble ratio for the select customer. The intelligence layer compares the predicted token ensemble to a compute ensemble ratio determined for each of two or more of other instances of the multimodal model. The intelligence layer re-assigns the select customer to a second instance of the multimodal model in response to determining that the predicted token ensemble ratio is more similar to the compute ensemble ratio of the second instance of the multimodal model than to the compute ensemble ratio of the first instance of the multimodal model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates aspects of an example model-as-a-service (MaaS) platform that implements an intelligence layer to dynamically allocate resources among different modality-specific processing pipelines of a multimodal model instance.

FIG. 2 illustrates additional aspects of an example intelligence layer deployed within a MaaS platform that performs dynamic, modality-specific resource allocation for a multimodal model instance.

FIG. 3 illustrates example aspects of a MaaS platform including an intelligence layer that dynamically reassigns customers to different model pools to improve resource utilization efficiency.

FIG. 4 illustrates an example MaaS platform that selectively assigns customers to model pools based on predicted token ensemble ratios and compute ensemble ratios that describe the allocation of resources within each different model pool.

FIG. 5 illustrates example operations for dynamically reallocating processing resources among dedicated groups that that respectively support different modality-specific processing pipelines of a multimodal model instance.

FIG. 6 illustrates example operations for improving resource utilization within a MaaS platform that includes multiple instances of a multimodal model.

FIG. 7 illustrates an example schematic of a processing device suitable for implementing aspects of the disclosed technology.

### DETAILED DESCRIPTION

The herein-disclosed technology provides solutions for dynamically reallocating processing resources within a MaaS platform to efficiently utilize processing resources while also guaranteeing a baseline level of performance to end customers that submit diverse types of requests to multimodal models.

In a typical multimodal model architecture, different modality-specific processing pipelines support the processing of data of different modalities. For example, a multimodal model may include a video pipeline with a video encoder that embeds video data as input tokens, a language model that receives the input tokens from the video encoder, and a video decoder that receives output tokens generated by the language model that translates the output tokens back into video data. A separate but similar pipeline (e.g., encoder, language model, and decoder) may be employed to process the data of each other modality supported by the model. In some cases, two or more different modality-specific pipelines use the same model to process input tokens and generate output tokens; however, the encoder and decoder components are typically not shared between modality-specific pipelines.

Within the above-described architecture, dedicated groups of GPUs are assigned to support each modality-specific processing pipeline (and each component within each pipeline). The allocation of these dedicated GPUs is complicated by the fact that the processing of a set quantity of tokens may vary significantly depending upon the modalit(ies) of data embedded within those tokens. To illustrate the complications in resource allocation within multimodal architectures, assume that it takes the multimodal modal (on average) one unit of compute power to process a token embedding natural language text, two units of compute power to process a token embedding image data, and three units of compute power to process a video token. If this model were to always process workloads with equal quantities of language, image, and video tokens, then a very rudimentary approach to resource allocation might provide for allocating compute units to the language, image, and video processing pipelines according to a 1:2:3 ratio. However, in real-world scenarios, significant variation exists in the relative quantities of tokens of different modalities included within each workload as well as across different customers. For example, one customer may routinely use a multimodal model to process tokens that embed video and audio data, while another customer may use the same model to process tokens that primarily embed language and image data.

When an individual modality-specific processing pipeline is allocated too few resources to process a particular customer request, the data of that pipeline may experience higher latency than the other parallel modality-specific processing pipelines of the same multimodal model. In contrast, over-allocation of processing resources results in resource waste in the form of processing resources that are powered on but not often used to their full capacity. It is expensive to purchase processing hardware and therefore undesirable to deploy processing resources that are used inefficiently.

Current multimodal architectures tend to allocate processing resources to model instances based on customer rate limits. The rate limit defines a maximum number of tokens per fixed interval of time that the customer is entitled to use, such as based on a subscription tier. Thus, given the known rate limit of each customer sharing access to a multimodal model instance, it becomes possible to construct a processing architecture for that model with sufficient compute power to guarantee that all customers can use up to their respective rate limit of tokens without experiencing latencies that exceed a target threshold, regardless of the data modalities being processed. Although the low latency promise of this approach is appealing, implementing this solution entails allocating resources to support worse-case needs with respect to each different data modality supported by the model. If, for example, all customers sharing access to a model instance have a rate limit of 10,000 tokens per minute, this approach ensures that compute power is allocated to ensure that every individual modality-specific processing pipeline is capable of processing up to 10,000 tokens per minute. However, a vast majority of customer requests are mixed-modality requests. For example, a customer with a 10,000 token per minute rate limit may, at peak demand time, be processing 6000 tokens of text, 2000 tokens of audio, and 1000 tokens of video. Therefore, the above-described approach often results in allocations that significantly exceed the compute power that is, on average, used, which amount to undesirable resource waste.

The herein-disclosed resource allocation techniques improve cloud-based service management by optimizing resource utilization as compared to the above-described approaches. The disclosed resource allocation techniques reduce over-allocations of resources that amount to resource waste, which in turn reduces operational costs for providers of model-as-a-service platforms and other cloud providers that rely on processing by cloud-based models. At the same time, the disclosed resource allocation techniques guarantee a baseline level of performance (e.g., low latencies) to customers of the model-as-a-service platforms and customers of other cloud service providers that utilize cloud-based models. According to one implementation, resources are dynamically reallocated between different modality-specific processing pipelines of a multimodal model based on forward-looking, modality-specific predictions of customer utilization. This is achieved by employing an “intelligence layer” to generate dynamic modality-specific workload predictions of future customer token utilization based on short-term customer trend data. For example, each modality-specific workload prediction sets forth quantities of tokens for each modality supported by the model that the customer is likely to use at each hour of the day over the next week.

The herein-disclosed approach further provides for using the modality-specific workload predictions to predict latencies expected to occur within each different modality-specific processing pipeline of a multimodal model based on current allocations of processing resources across the processing pipelines. When the latency prediction for a particular modality-specific processing pipeline exceeds a target max threshold, the intelligence layer attempts to reallocate resources to that pipeline from another modality-specific processing pipeline of the same model that is not predicted to be operating near its max capacity.

In some implementations, the herein-disclosed intelligence layer re-assigns customers to different model instances based, in part, on the modality-specific workload predictions. If, for example, the predictive data indicates that all modality-specific processing pipelines are expected to be heavily used and operating near max capacity over the future time interval, it may not be possible to reallocate resources between the different modality-specific processing pipelines while still hitting latency targets. In these cases, customers can be re-assigned to alternative instances of the same model that are predicted to experience lower usage during the future time interval. This guarantees that workload outputs are not, for any customer, delayed due to bottleneck processing of tokens of a single modality.

In still further implementations, the disclosed resource management techniques include traffic classification operations to match individual customers to specific instances of a multimodal model based on the above-mentioned modality-specific predictions of token usage and, more specifically, based on predicted relative quantities of tokens of different modalities that a customer is predicted to use. This approach entails matching a distribution of the predicted relative quantities of tokens of different modalities that the customer is expected to use to an instance of the requested multimodal model that is instantiated within a computing architecture with a most similar distribution of relative compute power across the modality-specific processing pipelines. For example, a customer that is predicted to process twice the number of audio tokens as image tokens may be assigned to a select model instance instantiated within a hardware architecture, allocating approximately twice the number of compute units to support audio processing as image processing. This “matching” of customers to modal instances based on modality-specific token usage predictions and modality-specific resource distributions ensures that the requests of users with similar compute needs are routed to the same model instance (or the same pool of models supported by identical processing hardware); this, in turn, ensures that all customers sharing a model instance or model pool are guaranteed to experience latencies below a target max latency while also guaranteeing a target utilization rate of the compute resources that is sufficiently high (e.g., 75% or more), meaning resources waste is minimal.

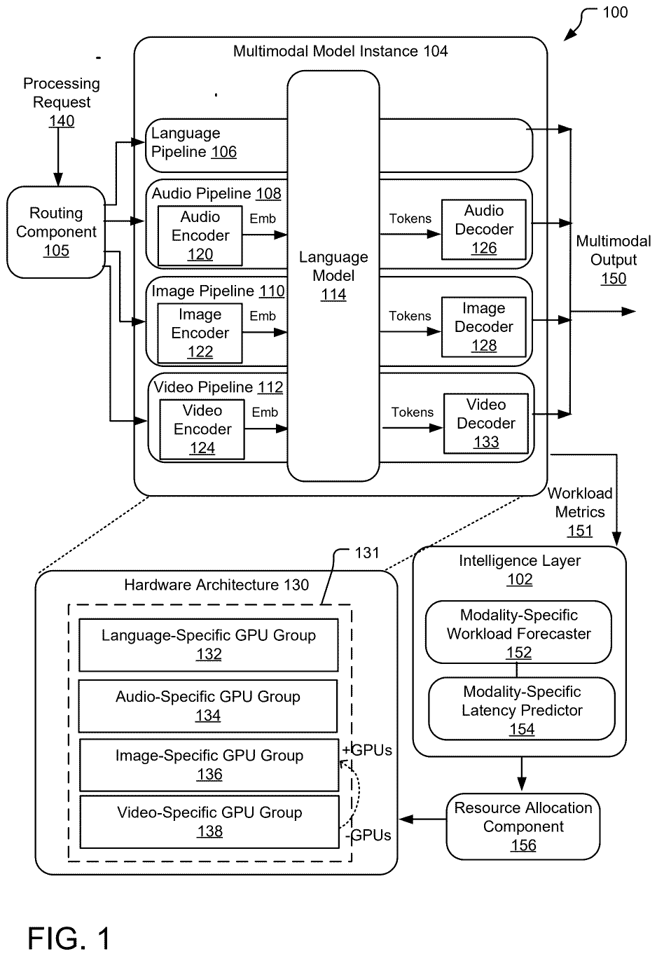

FIG. 1 illustrates aspects of an example model-as-a-service (MaaS) platform 100 that implements an intelligence layer 102 to dynamically allocate resources among different modality-specific processing pipelines of a multimodal model instance 104. The multimodal model instance 104 supports processing at least two different modes of data, referred to herein as “modalities,” but may, in various implementations, support different numbers and types of modalities. As used herein, a “data modality” refers to a distinct type or source of data that has unique characteristics and structures. Different modalities convey information in various formats, such as text, images, audio, video, or sensor readings, each requiring specialized processing methods to interpret its information accurately.

In the example shown, the multimodal model instance 104 includes a language model 116. As used herein, the term “language model” refers to a model that is trained to interpret textual inputs and generate textual outputs. Textual inputs and outputs consist of written words, characters, or symbols that represent language, ideas, or concepts. It can include letters, punctuation, and spaces. Per the above definition, the term “language model” encompasses natural language processing (NLP) models as well as models that process other types of textual inputs, including text-based code and textual characters. Example types of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs).

When a language model is trained on a corpus of data that includes text-based representations of data of different modalities (e.g., text-based representations of audio data, text-based representations of images), the language model becomes capable of making multimodal inferences-meaning, making inferences based on tokens of non-language modalities and generating tokens that embed data of non-language modalities. This multimodal capability is leveraged by instantiating the language model within an architecture that includes additional encoder/decoder pairs for encoding and decoding non-textual data, as shown in FIG. 1 (see, for example, encoder and decoder elements within audio pipeline 108, image pipeline 110, and video pipeline 112). Due to this architecture, the language model 116 is configured for multimodal inferencing and is thus referenced herein as the multimodal model instance 104. Examples of publicly available language models configured to perform multimodal inferencing include the Mistral AI model and the large language model Meta AI (LLaMa) model.

The multimodal model instance 104 includes a different data processing pipeline dedicated to processing data of each different supported modality. These different “modality-specific processing pipelines” include the language pipeline 106, the audio pipeline 108, the image pipeline 110, and the video pipeline 112.

When a user submits a processing request 140 specifying a particular language model identifier (e.g., model type and version), the request is received and routed to the multimodal model instance 104 by routing component 105 of the MaaS platform 100. The routing component 105 decomposes the payload of the processing request 140 (e.g., the data that is to be processed by the language model) into modality-specific data streams such as language data, audio data, image data, and video data, and routes each of these modality-specific data streams to an entry point of a corresponding one of the above-described modality-specific processing pipelines. Natural language text data is routed to the language pipeline 106, audio data is routed to the audio pipeline 108, image data is routed to the image pipeline 110, and video data is routed to the video pipeline 112.

Since the language model 116 is trained to process tokens that store text, non-textual data within processing request 140 (e.g., binary data formats) is translated into corresponding text-based representations before being passed to the language model 114. This translation is performed by modality-specific encoders (e.g., an audio encoder 120, an image encoder 122, and a video encoder 124) that each receive input data of the corresponding modality and that translates that data into a sequence of text-based embeddings (“tokens”) that can be received and processed by the language model 116. After these tokens are processed by the language model 116, a reverse translation is performed to return data that matches the initial input format of the corresponding pipelines. This reverse translation is performed by modality-specific decoders (e.g., an image decoder 128, an audio decoder 126, and a video decoder 133).

Notably, the language pipeline 106 is not shown to include an encoder or decoder external to the language model 116. This is because the language model 116 already includes a language encoder that translates natural language text to text-based embeddings and a language decoder that translates text-based embeddings back to natural language text.

As data flows through the language model 116 along each different modality-specific processing pipeline, the text-based embeddings are passed through and operated on by different layers of the language model 116. In an implementation where the language model 116 has a decoder-only transformer model architecture (e.g., a GPT model), the embeddings flowing along each parallel path (e.g., the language pipeline 106, audio pipeline 108, image pipeline 110, and video pipeline 112) are passed through a sequence of decoding layers that each includes an attention block, one or more normalization blocks, and a feedforward layer. The attention block computes attention for each token being processed, and the attention information is then normalized and passed to the next decoding layer, which performs similar operations. The data flowing through the different modality-specific pipelines may be processed in parallel, and the attention blocks within each parallel flow may likewise support cross-modality attention by performing computations based on token information stored in a shared cache (e.g., a key-value cache). This cross-modality attention allows the language model 116 to learn how tokens of different modalities depend upon and relate to one another. Tokens generated by the language model 114 are output and decoded along their respective pipelines, as shown, and then combined as a multimodal output 150 that is returned to the client device that submitted the processing request 140.

In some implementations, the multimodal model instance 104 implements an ensemble model. Instead of including the language model 116 shared across all of the modality-specific pipelines as shown, two or more of the modality-specific processing pipelines in the ensemble model include separate model instances that process data completely independently of one another (e.g., without cross-modality attention). In an ensemble model, tokens output by different models are decoded and combined to generate the end result that is returned to the requesting client service. Thus, although the software infrastructure of these types of ensemble models may be quite different from the architecture described above, the allocation of processing resources among the different modality-specific pipelines may, in both types of models, be achieved by applying the same novel allocation methodologies disclosed below. As used herein, the term “multimodal model” is therefore intended to encompass both true multimodal models with cross-modality attention mechanisms as well as ensemble models that utilize two or more different language models to process different modalities of data.

In the MaaS platform 100, the multimodal model instance 104 is instantiated within a hardware architecture 130 that allocates a dedicated group of processing resources (e.g., graphics processing resources (GPUs) or accelerators) to support the processing operations that occur along each one of the different modality-specific processing pipelines (e.g., the language pipeline 106, the audio pipeline 108, the image pipeline 110 and the video pipeline 112). These dedicated groups of processing resources are referred to herein as “modality-specific compute groups 131.” In FIG. 1, the modality-specific compute groups 131 include a language-specific GPU group 132, an audio-specific GPU group 134, an image-specific GPU group 136, and a video-specific GPU group 138. In other implementations, some or all of the modality-specific compute groups 131 include dedicated hardware accelerators in addition to or in lieu of GPUs.

The compute power provided by each different one of the modality-specific compute groups 131 varies based on the number and type of processing resources in each group. There is no requirement that compute power be evenly allocated among the modality-specific compute groups 101 and, in most cases, this allocation is unequal.

The intelligence layer 102 of the MaaS platform 100 is a group of software components that execute operations to affect dynamic, inter-model resource reallocations during nominal use of the multimodal model instance 104 by end customers. These dynamic resource reallocations are “inter-model” in the sense that processing resources are dynamically re-assigned among the modality-specific compute groups 131 in response to predicted changes in token utilization of the different modalities.

The intelligence layer 102 receives workload metrics 151 from the multimodal model instance 104 on behalf of each customer (e.g., customer ID). The workload metrics 151 indicate, for each processing job, a customer ID, as well as an observed modality-specific token usage for the workload (e.g., the number of input tokens processed of each different supported modality). In some implementations, the workload metrics 151 include other information, such as utilization for specific types of tokens—e.g., input tokens, generated tokens, and cached tokens.

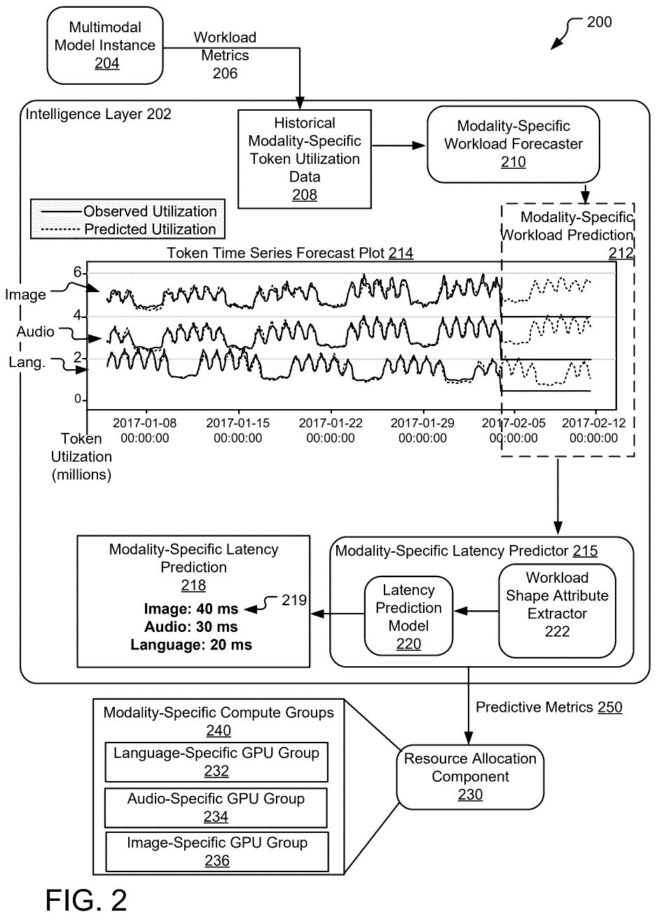

The intelligence layer 102 collects and aggregates the workload metrics 151 from the various requests processed by the multimodal model instance 104 on behalf of different customers. A modality-specific workload forecaster 152 uses the modality-specific token usages reported in the workload metrics 151 to repeatedly generate a forward-looking modality-specific prediction of future token utilization for each customer. For example, the modality-specific workload forecaster 152 uses the workload metrics 151 collected over the past interval (e.g., the past two or three weeks) for a given customer to generate a modality-specific workload prediction that estimates how many tokens of each modality the customer is likely to use over a future interval (e.g., next few days or the next one week). Exemplary methods for this prediction are discussed with respect to FIG. 2.

The modality-specific workload predictions generated by the modality-specific workload forecaster 152 for different customers are passed to a modality-specific latency allocates 154 that uses the predicted modality-specific token utilization prediction data across all customers of the multimodal model instance 104 to generate a modality-specific latency prediction for the multimodal model instance 104 across the future time interval. This modality-specific latency prediction includes a predicted latency that is expected to be observed within each different one of the modality-specific processing pipelines during the future time interval, assuming that there is no change to the current allocation of processing resources among the modality-specific compute groups 131. A further discussion of this latency prediction is presented, with more detailed examples, in the discussion of FIG. 2 below.

In one implementation, the intelligence layer 102 evaluates the predicted values for the maximum latency to be observed within each processing pipeline latency against a threshold representing a maximum acceptable latency to determine which, if any, of the modality-specific processing pipelines is expected to be impacted by latency that exceeds the threshold. Results of this evaluation are provided as input to a resource allocation component 156 that dynamically reallocates processing resources (e.g., GPUs) among the modality-specific compute groups as needed to ensure that no individual one of the modality-specific processing pipelines experiences a latency that exceeds the threshold during the future interval.

FIG. 2 illustrates additional aspects of an example intelligence layer 202 deployed within a MaaS platform 200 that performs dynamic, modality-specific resource allocation for a multimodal model instance 204. In one implementation, the multimodal model instance 204 is integrated within a system architecture the same or similar to that described above with respect to FIG. 1. Within the multimodal model instance 204, data of different modalities is processed along different processing pipelines (modality-specific processing pipelines, as generally described with respect to FIG. 1), with each different processing pipeline being supported by a different, dedicated group of processing resources. In FIG. 2, the different dedicated groups of processing resources are collectively shown as “modality-specific compute groups 240,” which includes a language-specific GPU group 232, an audio-specific GPU group 234, and an image-specific GPU group 236.

The multimodal model instance 204 processes workloads on behalf of multiple different customers of the MaaS platform 200 and provides the intelligence layer 202 with workload metrics 206 specific to each workload and each customer identifier. The workload metrics 206 indicate, for each workload processed, a customer ID as well as the modality-specific token counts observed for the workload. The modality-specific token counts identify the number of tokens processed for each different supported modality and, in some implementations, further identify counts for different types of tokens processed within each modality-specific processing pipeline. For example, the workload metrics 206 indicate the number of input tokens processed, cached tokens processed, and output tokens generated that are of each different data modality (e.g., image, language, audio, video).

Over time, the intelligence layer 202 collects and aggregates the workload metrics 206 pertaining to each individual customer that uses the multimodal model instance 204. This collected, aggregated data is shown in FIG. 2 as “historical modality-specific token utilization data 208.” A modality-specific workload forecaster 210 uses the historical modality-specific token utilization data 208 to generate, for each customer, a modality-specific workload prediction 212. The modality-specific workload prediction 212 includes modality-specific time series distributions of token counts. The modality-specific time series distributions predict token utilization for each supported modality of the multimodal model instance 204 during each of multiple discrete time increments throughout a future time interval.

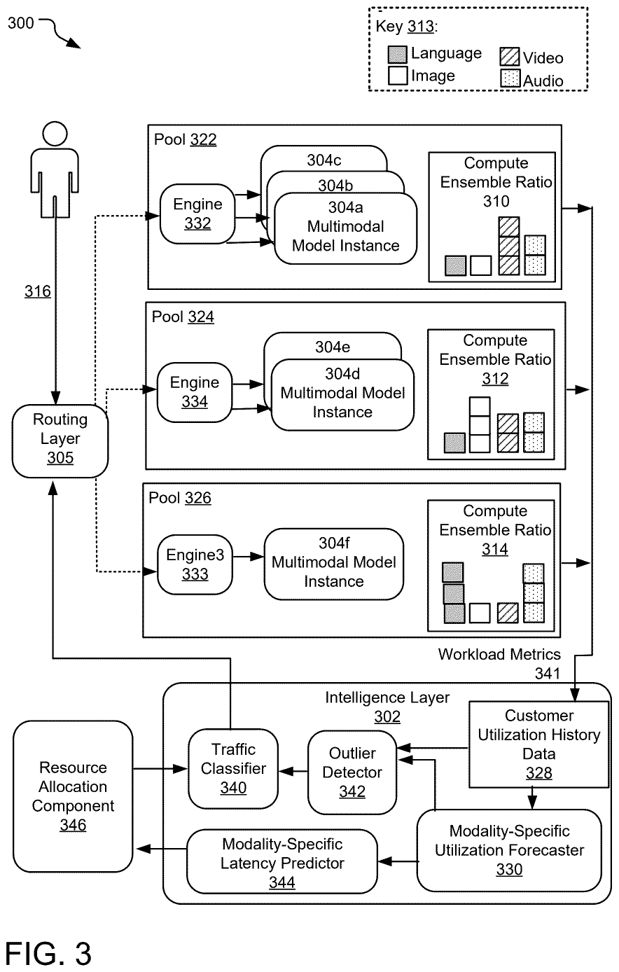

In FIG. 2, a token time series forecast plot 214 illustrates various time series distributions quantifying token utilization (e.g., in fixed time increments such as per hour utilizations) for each of three types of modalities-image, audio, and language that are supported by the multimodal model instance 204. It is assumed that the data shown is representative of token utilization by an individual customer. The x-axis illustrates time, and the y-axis illustrates token consumption, which is also referred to herein as “token utilization.” As used herein, “token utilization” refers to token processing that is performed by a language model. As a token is processed (e.g., fed into the model or generated by the model), the token is said to be “consumed” or “utilized.” Token utilization is represented in FIG. 3 in terms of the number of tokens processed by the multimodal model instance within each of multiple fixed time increments (e.g., hours) within a larger time interval represented by the x-axis data.

Notably, the token time series forecast plot 214 includes three solid lines, each identifying a distribution of (actual) token utilization of a corresponding respective modality (e.g., audio, image language) for the customer over a previous time interval. In addition, the token time series forecast plot 214 also includes dotted lines that identify predicted token utilizations for the same customer and for the same three different modalities-image, audio, and language. The three dotted lines shown on the token time series forecast plot 214 collectively represent the modality-specific workload prediction 212 that is generated for an individual customer and for a multimodal model that supports three different modalities.

In the example shown, the token count utilization represented on the y-axis corresponds to net token utilization across all token types (e.g., the sum of all input tokens, cache tokens, and generated tokens processed during a workload). However, in other implementations, the modality-specific workload forecaster 210 generates a different version of the token time series forecast plot 214 for different “types” of token processed by each modality-specific pipeline. Examples of types of tokens include input tokens (e.g., tokens embedded, processed, and typically cached by a given processing pipeline), generated tokens (e.g., tokens generated and output by the language model), and cached tokens. The term “cached token” refers to a token retrieved from the cache and used for a computation. In a multimodal model instance, input tokens processed and cached by one modality-specific processing pipeline (e.g., language) may be retrieved from the cache and used by other modality-specific processing pipelines. Therefore, some pipelines process a number of cached tokens that is different than the number of input tokens received of that modality. In one implementation, the modality-specific workload prediction 212 includes a predicted utilization (token count) for each type of token (input, output, and cached) that is processed along each different modality-specific processing pipeline.

In different implementations, the modality-specific workload forecaster 210 employs different predictive modeling algorithms to generate the modality-specific workload prediction 212. One suitable approach is to use a seasonal decomposition prediction model that decomposes the customer's time series data within the collected workload metrics 206. For example, a seasonal decomposition model may employ an algorithm to breaks down time series data into trend, seasonal, and residual components that are, in turn, processed by a model to generate a forecast that extrapolates the trend forward in time while adjusting for seasonal patterns and accounting for residual noise. One example of a seasonal decomposition prediction model is STL (Seasonal and Trend decomposition using Loess) model.

The modality-specific workload forecaster 210 recreates the modality-specific workload prediction 212 on a recurring basis. For example, the modality-specific workload prediction 212 is re-generated for each customer on each day of the week. The modality-specific workload prediction 212 spans a future time interval (e.g., the next one week) and is based on the historical modality-specific token utilization data 208 collected for the customer over a recent time interval, such as the past two or 3 weeks. In different implementations, the modality-specific workload prediction 212 includes time series data with varying degrees of granularity. By example, this data may identify a quantity of tokens for each supported modality of data (e.g., language tokens, audio tokens, video tokens, image tokens) that is predicted to be processed on behalf of a particular customer during each respective hour of the day over the next week.

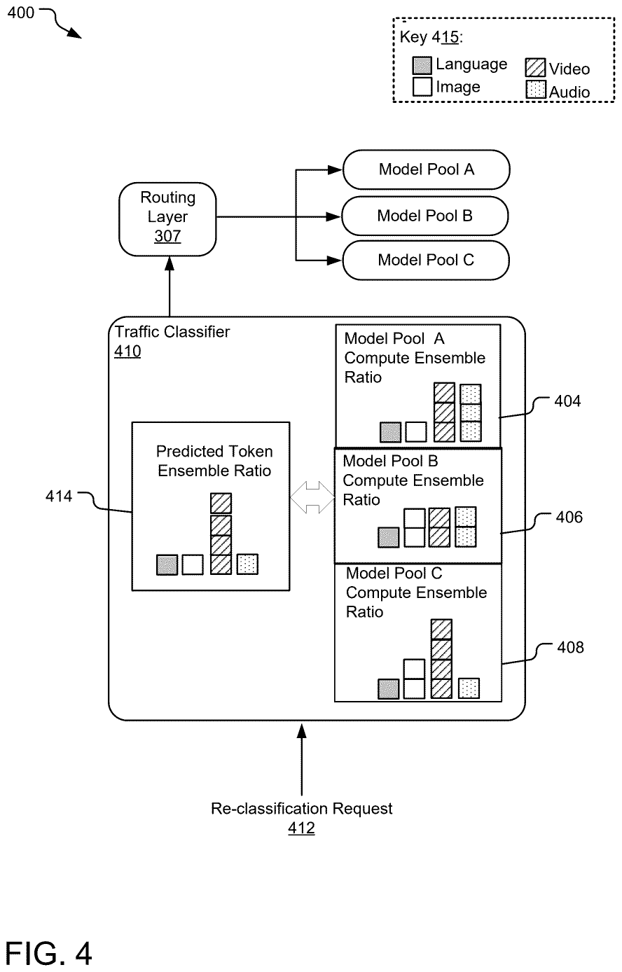

In one implementation, this forecast is customer-specific and provides metrics that facilitate traffic classification actions described herein with respect to FIGS. 3 and 4.

In one implementation, a different instance of modality-specific workload prediction 212 are generated for all customers of the multimodal model instance 204 at each prediction interval. For example, the modality-specific workload prediction 212 predicts modality-specific token utilization over the next one week and is generated for all customers that have used the multimodal model instance 204 during the past two or three weeks.

The modality-specific workload prediction 212 of each individual customer is passed into a modality-specific latency predictor 215, which generates a modality-specific latency prediction 216 for the customer during the future time interval. The modality-specific latency predictor 215 may be understood as comprising executable code including a model (e.g., a latency prediction model 220) and software components (e.g., a workload shape attribute extractor 222) that prepare inputs to the model.

In different implementations, the modality-specific latency prediction 218 is generated in different ways and includes predicted values for different types of latency metrics. In all implementations, however, the modality-specific latency prediction 218 includes modality-specific values that quantify a predicted latency that is expected to be observed during the future interval within each different modality-specific processing pipeline of the multimodal model instance 204 (e.g., a predicted latency 219 for the image pipeline). By example, the predicted latency may be a value for a time-between-tokens (TBT) metric that is specifically computed for each different modality-specific processing pipeline—e.g., audio, image, and language.

The TBT metric is widely used to quantify the relative performance of difference generative AI models by measuring how consistent a model is in producing tokens at regular intervals. An example formula for computing TBT for a given data modality is given by:

$$TBT = \frac{( TTLT - TTFT )}{{NumberTokens}_{generated}}$$

where TTFT represents the total time that it takes the model to generate the first token of the modality, TTLT represents the total time that it takes the model to generate the last token of the modality, and NumberTokensgenerated represents the total number of tokens generated for the modality.

In the example of FIG. 2, the predicted modality-specific latency prediction 218 is generated by a trained model, shown as “latency prediction model 220.” This model is trained on a reference dataset that includes workload shape attributes for previous workloads and corresponding latency metrics (e.g., TBT values) observed during execution of the corresponding workloads by the multimodal model instance 204 or identical model instances thereof instantiated within hardware architectures characterized by different, known distributions of processing resources among the modality-specific compute groups of 240.

As used herein, the term “workload shape attribute” refers to a statistical measurement that is usable to describe the shape of a distribution, such as the example time series distributions shown by the dotted lines in the token time series forecast plot 214. Examples of workload shape attributes include statistical metrics such as means, standard deviations, variances, and configurable percentiles.

In modeling studies, certain workload shape attributes have been identified as correlating with latency (e.g., TBT values and other metrics that quantify latency) in the modality-specific processing pipelines of multimodal models. Specifically, the number of tokens generated for a given modality has proven to be a strong indicator of the latency (e.g., TBT) observed within the processing pipeline supporting that modality. A weaker but still notable correlation has likewise been demonstrated with respect to the number of input tokens processed for a given modality and the number of cached tokens processed for a given modality.

Thus, in one implementation, the latency prediction model 220 is trained on reference data corresponding to different historical workloads that identifies, for each workload: (1) token modality types processed in the workload; (2) workload shape attributes extracted from time series distributions that describe token utilization for each of the token modality types; and (3) a label identifying the respective TBT value observed in the processing pipeline supporting each different modality. For example, this set of inputs may identify P50 and P95 values of a first time series token utilization distribution corresponding to “modality type=image” and a second-time series token utilization distribution corresponding to “modality type=language.” In some implementations, the workload shape attributes (2, above) identify aspects of token utilization in addition to modality, such as by specifying for each different modality the number of tokens of the modality generated by the model, the number of tokens of the modality input to the model, or the number of tokens of the modality that the model retrieves from a cache. Since these types of workload shape attributes are (as described above) known to be correlated with observed latency, including this specific information in the training data allows similar workload shape attributes to be used to predict latency with higher accuracy than other presently-existing approaches.

In another implementation, the sets of training inputs to the latency prediction model 220 include workload shape attributes specific to both modality and token type (e.g., input, cached, or generated). For example, a workload shape attribute (e.g., a P95 value for a time series distribution) is identified as being specific to the time-series data for “modality type=image tokens” and “token type=generated tokens.”

In FIG. 2, the modality-specific latency predictor 215 is shown to include a workload shape attribute extractor 222, which includes logic executable to extract the workload shape attributes from the time series distributions included in the modality-specific workload prediction 212. Assume, for example, that the modality-specific workload prediction 212 includes a predicted time-series distribution of token utilization for each different token type (e.g., input tokens, cached tokens, and generated tokens) and each supported modality. For instance, the modality-specific workload prediction 212 includes a first time-series distribution that predicts a quantity of image tokens received as input each hour over the future interval, a second time-series distribution that predicts a quantity of cached image tokens processed each hour over the future interval, and a third time-series distribution that predicts a quantity of image tokens generated each hour. Now, further assume the modality-specific workload prediction 212 includes these same three distributions for each of the different modalities supported by the multimodal model instance 204, for a total of nine time-series distributions per customer (assuming three modalities), each being specific to one of three token types and a different modality.

In the above-described example where the modality-specific workload prediction 212 includes nine different time-series distributions per customer, the workload shape attribute extractor 222 extracts workload shape attributes from all nine distributions and inputs those workload shape attributes to the latency prediction model 220. Extracting the workload shape attributes may, for example, include determining predefined configurable percentile values for each distribution that match the same types of configurable percentile values represented in the training dataset for the latency prediction model 220. For example, the workload shape attribute extractor determines P50 and P95 values for the predicted time-series token distribution that is specific to “modality type=image” and “token type=generated tokens.” Likewise, these same configurable percentile values may be extracted from each other one of the time-series distributions included within the modality-specific workload prediction 212.

Given the above-described reference data used to train the latency prediction model 220, the latency prediction model 220 can predict modality-specific latency statistics likely to be observed in association with specific sets of workload shape attributes. Thus, when provided with a set of inputs that identifies: (1) a current allocation of processing resources across modality-specific compute groups 240 for the multimodal model instance 204 and (2) a predicted set of workload shape attributes extracted from the modality-specific workload prediction 212 of a given customer, the latency prediction model 220 generates the modality-specific latency prediction 218 for the customer.

As described above and shown in FIG. 2, the modality-specific latency prediction 218 identifies a predicted latency that is expected to be observed within each of the modality-specific pipelines of the multimodal model instance 204 while processing data on behalf of the customer over the future time interval. In one implementation, the intelligence layer 202 computes the modality-specific workload prediction 212 and the modality-specific latency prediction 218 for each customer assigned to use the multimodal model instance 204 during the future interval. Since the multimodal model instance 204 processes customer requests one at a time (in series), a “maximum predicted latency” for a select modality-specific processing pipelines (e.g., the image pipeline) is given by the greatest “predicted latency” that is determined for that select pipeline across the complete set of customers assigned to the multimodal model instance 204. If, for example, there are three customers assigned to the multimodal model instance 204 and for the three customers, the predicted latencies for the image pipeline are 20 ms, 31 ms, and 40 ms, the 40 ms value represents the maximum predicted latency of the image pipeline over the future time interval.

In one implementation, the modality-specific latency predictor 215 compares the maximum predicted latency for each of the modality-specific processing pipelines to a first threshold representing a maximum permissible latency. When the maximum predicted latency for one of the modality-specific processing pipelines exceeds the first threshold, the modality-specific latency predictor 215 instructs resource allocation component 230 to attempt a dynamic re-allocation of resources among the modality-specific compute groups 240. The objective of the allocation is to ensure that no individual one of the modality-specific processing pipelines experiences an actual latency during the future time interval that exceeds the first threshold. Such a reallocation is possible at times when the maximum predicted latency for at least one of the other modality-specific processing pipelines is below a second threshold-meaning, there exist an ample number of processing resources in another one of the modality-specific compute groups 240 that are predicted to remain unused throughout the future time interval. If, for example, the image-specific GPU group 236 is predicted to have a maximum latency above the first threshold and the audio-specific GPU group 234 is predicted to have a maximum latency below the first threshold by a margin in excess of a second threshold, it may be possible to reallocate GPU from the audio-specific GPU group 234 to the image-specific GPU group 236 and, as a result, reduce actual maximum latency for the image-specific processing pipeline below the first threshold without increasing actual maximum latency of the audio-specific pipeline above the first threshold.

In one implementation, the resource allocation component 230 stores a translation function for each different modality-specific compute group 240 that facilitates translation between a latency overage or underage relative to a threshold and a quantity of compute units sufficient to eliminate the latency overage or underage in relation to the threshold. For example, these translation functions can be determined experimentally by modeling changes in latency that result within the different modality-specific processing pipelines while compute resources are incrementally added and/or subtracted to the corresponding modality-specific compute groups 240. The translation functions may be implemented in the form of one or more look-up tables, computable equations that depend upon the maximum latency predictions for the different modality-specific processing pipelines, or any other suitable format.

Once the modality-specific latency predictor 215 identifies the maximum predicted latency for each modality-specific processing pipeline by comparing the modality-specific latency predictions across all customers (as generally described above), the maximum predicted latency for each modality-specific processing pipeline is passed, within predictive metrics 250, to the resource allocation component 230. In some cases, the predictive metrics 250 additionally or alternatively specify a determined latency overage or underage for each of the modality-specific processing pipelines relative to the maximum latency threshold.

Using the predictive metrics 250 in view of the above-described translation functions and/or reference datasets, the resource allocation component 230 determines a target subset of compute units (e.g., GPU type and quantity) to add to any one of the modality-specific processing pipelines to reduce a predicted latency for that processing pipeline by a target amount (e.g., below the first threshold representing the maximum permissible latency). If, for example, the image processing pipeline is predicted to experience a 2 millisecond (ms) overage in excess of the max latency threshold, the resource allocation component 230 may access a reference dataset (e.g., a lookup table) to identify a subset of processing resources (e.g., a quantity and type of GPU) that could, if reallocated to the image-specific GPU group 236, eliminate the 2 ms latency overage. Using the same reference dataset, the resource allocation component 230 can likewise determine an increase in predicted latency that is to be incurred by removing the target subset of compute units from any other one of the modality-specific compute groups 240. Per the analysis, the resource allocation component attempts to rebalance the GPUs in a way that better matches the predicted demand by identifying one or more suitable “donor groups” from the modality-specific compute groups 240 (e.g., an audio-specific GPU group 234 or a language-specific GPU group 232) that collectively have a surplus of resources as large as the target subset of compute units. A modality-specific compute group is described herein as having a “surplus” of compute units when the compute units can be removed from the donor group without causing the modality-specific processing pipeline supported by the donor group to incur an increase in latency that results in a latency overage above the maximum latency threshold.

Although the scenario described above relates to resource allocation that is performed due to a single customer's changing token utilization pattern, the above-describe operations may understandably be performed once, for an entire prediction interval (e.g., the next 1 week) by reallocating resources based on the “maximum” latency that is predicted for each processing pipeline across all customers of the multimodal model instance 204. Assume, for example, that the latency prediction for customer A indicates an image pipeline latency of 40 ms and an audio pipeline latency of 30 ms, while the latency prediction for customer B indicates (for the same future time interval) an image latency of 36 ms and an audio pipeline latency of 37 ms. Provided there are no other customers assigned to use the multimodal model instance 304, the resource allocation component 230 may, in this case, determine that the image processing pipeline has a maximum predicted latency of 40 ms (due to customer A) and that the audio processing pipeline has a maximum predicted latency of 37 ms (due to customer B). Therefore, when looking for the compute group that can serve as donor of surplus resources to the image processing pipeline, the resource allocation component 230 uses the maximum predicted latency of 37 ms for the audio pipeline to assess the quantity of available (surplus) resources in the audio-specific compute group. This ensures that the resulting resource re-allocations are sufficient to meet latency targets continuously throughout the future time interval-regardless of which customer's workload is being processed.

Provided one or more suitable donor groups can be identified from the modality-specific compute groups 240 per the above-described analysis, the resource allocation component 230 reallocates the target subset of compute units from the donor group to the group that is predicted to otherwise experience the latency overage. For example, the resource allocation component 230 reallocates a bank of GPUs from the language-specific GPU group 232 to the image-specific GPU group 236. Due to this reallocation, the predicated latency for the image-specific GPU group 236 is reduced from 40 ms to 37 ms, which is below the maximum latency threshold of 38 ms. Additionally, the predicted latency for the language-specific GPU group 232 increases from 20 ms to 25 ms; however, this is permissible because 25 ms is well below the maximum latency threshold of 38 ms.

Notably, there exist some scenarios in which it is not possible to re-allocate the target subset of compute units among the modality-specific compute groups 240 of the multimodal model instance 204 without driving the latency of the processing pipeline of the donor group(s) above the maximum latency threshold. This may be the case if, for example, all of the modality-specific processing pipelines of the multimodal model instance 204 are predicted to be used by at least one customer in a high capacity such that each of the modality-specific processing pipelines is expected to experience latency within a fixed delta of the maximum latency threshold.

In these scenarios where inter-model resource allocation is not possible without exceeding the max latency threshold, the intelligence layer 202 may attempt to re-assign customers to alternative instances of the same model, such as alternative instances supported by processing resources at the same location (e.g., datacenter) or other location. This logic is discussed in detail with respect to FIG. 3.

Utilizing the above-described operations to reallocate resources among dedicated resource groups supporting different modality-specific pipelines of a multi-modal model instance allows individual resources dedicated to a model to be utilized with a higher level of efficiency (closer to a target utilization), which reduces the number of costly processing resources that the cloud service provider (e.g., the MaaS platform provider) purchases and supplies power to. This methology likewise makes it possible to guarantee customer workloads are not subjected to latencies greater than a predefined maximum (e.g., the above-discussed maximum latency threshold, which is set by the MaaS platform provider).

FIG. 3 illustrates example aspects of a MaaS platform 300 including an intelligence layer 302 that dynamically reassigns customers to different model pools to increase resource utilization efficiency. As used herein, a “dynamic” customer reassignment refers to a reassignment of an existing MaaS platform customer that is carried out by the MaaS platform 300 and without receiving a system-external request, such as a request from a service technician of the MaaS platform 300 or a customer of the MaaS platform 300.

The MaaS platform 300 is shown to include three model pools 322, 324, and 326. Each of these model pools includes one or more instances of a same multimodal model. The pool 322 includes model instances 304a, 304b, and 304c; the pool 324 includes model instances 304d and 304e; and the pool 326 includes instance 304f. Each of the different model instances 304a-304a implements an identical model type and identical model version.

Although not shown, each individual one of the multimodal model instances 304a-304f has a set of modality-specific processing pipelines with characteristics the same or similar to that shown in FIG. 1. The modalities supported by the model instances 304a-304f include language tokens, video tokens, audio tokens, and image tokens. Therefore, the modality-specific processing pipelines of each one of the model instances 304a-304f include a language processing pipeline, a video processing pipeline, an audio processing pipeline, and an image processing pipeline. Each different one of the multimodal model instances 304a-304f is instantiated within a hardware architecture that allocates a dedicated group of processing resources (“a modality-specific compute group”) to support each different one of the modality-specific processing pipelines of the model instance. A distribution of compute power among the modality-specific compute groups of each individual model instance varies depending upon which of the three model pools that model instance belongs to.

The model pools 322, 324, and 326 each have a distribution of processing resources that is described by a different compute ensemble ratio 310, 312, or 314. In the following description, the term “compute ensemble ratio” is used to refer to a ratio that identifies (e.g., defines or otherwise describes) a relative distribution of compute power among the dedicated groups of processing resources supporting the different modality-specific processing pipelines of a single multimodal model instance. Notably, resource type (e.g., GPU type and memory size) may vary between hardware architectures supporting different instances of a same multimodal model. However, for purposes of this disclosure, it is assumed that it is possible to directly compare the compute power of different processing resources that support different modality-specific processing pipelines. Notably, this comparison is straightforward when all of the processing resources are identical. In implementations where the processing resources are of mixed types (e.g., different types of GPU with different memory offerings), this comparison depends upon a precise understanding of the relative compute power offered by each resource type and the ability to readily convert the compute power of different resources to quantities of a common unit type. This conversion can be performed using various methods known in the art that are external to the scope of this disclosure.

In the example shown, each one of the model instances 304a-304c in Pool 322 is instantiated within a hardware architecture that allocates compute power among the different modality-specific compute groups of each individual model instance in the pool according to a same fractional distribution, which is defined by a first compute ensemble ratio 310. With reference to key 313, the first compute ensemble ratio 310 can be understood as providing for an allocation of X percent of the total compute power allocated to a given model instance to the language pipeline of that instance, X percent to the image pipeline of that instance, 3X percent to the video pipeline of that instance, and 2X percent to the audio pipeline of that instance. This can be understood as a 1:1:3:2 ratio (e.g., per the ordering of compute groups given by: language:image:video:audio). Notably, the quantity of compute units equivalent to “X” may vary for different model instances in the model pool 322 since X represents a fractional quantity (e.g., 1/7) of the total compute power allocated to each model instance, and each model instance may be allocated a different net quantity of compute power.

Within the model pool 324, compute power of each model instance 304a, 304e is allocated among the different modality-specific compute groups of that instance according to a second compute ensemble ratio 312. The second compute ensemble ratio 312 provides for an allocation of “X” percent of the instance's total compute power to the language pipeline, 3X percent to the image pipeline, 2X percent to the video pipeline, and 2X percent to the audio pipeline. This can be understood as a 1:3:2:2 ratio (e.g., per the ordering of compute groups given by: language:image:video:audio). Within the model instance 304f in Pool 326, compute power is distributed according to a third compute ensemble ratio 314, which provides a compute power ratio of 3:1:1:3 (e.g., per the ordering of compute groups given by: language:image:video:audio).

When a customer transmits a processing request 316 to the MaaS platform 300, the processing request is received by a routing layer 305 that directs the processing request 316 to a corresponding one of the model pools 322, 324, or 326. Assignments of customers to model pools is described at length below.

Routing within each model pool is performed by an engine (e.g., engines 332, 334, and 336) that directs each received request to a corresponding select model instance within the model pool. In one implementation, the engines 332, 334, and 336 select the model instances to receive each request based on various criteria, such as by enforcing round-robin selection logic to evenly balance customers among the model instances in a given pool or by assigning requests to model instances based on model performance metrics (e.g., utilization metrics, latency metrics of each model instance). For example, each request may be selectively directed to a model instance that is identified as having the lowest utilization or highest throughput in the corresponding model pool.

In addition to the above-described assignment and routing tasks, the engines 332, 334, and 336 within each pool decompose the payload of each incoming sing processing request into modality-specific data streams such as language data, audio data, image data and video data, and then route each modality-specific data stream to an entry point for the corresponding data processing pipeline of the model instance.

In the MaaS platform 300, the intelligence layer 302 performs actions to “match” customers to corresponding model pools based, at least in part, on a token ensemble ratio that is determined for each individual customer and the compute ensemble ratios of the different model pools. As used herein, the term “token ensemble ratio” is used to refer to a ratio that describes relations between quantities of tokens of different modalities that the select customer utilizes or is predicted to utilize during a fixed time interval. The token ensemble ratio can be illustrated as a distribution with the y-axis representing a percentage of total tokens utilized (or predicted to be utilized) and the x-axis identifying different modalities. The data in this distribution identifies the percentage of total tokens utilized during a fixed time interval that are of each modality.

In one implementation, the predicted token ensemble ratio is derived from modality-specific workload prediction described above with respect to FIG. 2. If, for example, the customer is predicted to utilize exclusively image and language tokens and also predicted to use roughly twice as many image tokens as language tokens, the customer is said to have a predicted token ensemble ratio of 1:2:0:0 with the four consecutive numeral indices corresponding to language:image:video:audio (per the same notation as that described above with respect to the compute ensemble ratio).

In one implementation, each customer to the MaaS platform 300 has a unique customer identifier (ID) that is, at any given point in time, assigned to a single one of the model pools 322, 324, and 326. All processing requests associated with a same customer ID are directed, by the routing layer 305, to a same model pool until such time that the customer ID is re-assigned to a new model pool. The intelligence layer 302 of the MaaS platform 300 includes a traffic classifier 340 that assigns customers to model pools by comparing a most-recently predicted token ensemble ratio for each customer to the compute ensemble ratios 310, 312, 314 of the model pools 322, 324, 326. Each customer is assigned (and periodically re-assigned) to a select one of the model pools 322, 324, and 326 that is determined to have a compute ensemble ratio that is “best match” to the customer's token ensemble ratio.

For a new customer, there may not exist any stored customer utilization history data 328, which plays a primary role in dynamic re-assignments of customers to model pools, which are discussed at length below. Therefore, a new customer to the MaaS platform 300 may, in different implementations, be initially assigned to a model pool in a variety of different ways. In one implementation, round-robin logic is enforced to assign new customers among the model pools in a substantially even fashion. In another implementation, customer profile data is used to select an initial model pool for a customer who is new to the MaaS platform 300. For example, a new customer may configure a profile that includes data such as enterprise industry, enterprise size, a description of good(s) or service(s) sold by the customer, or a description of the types of queries that the customer intends to submit to the MaaS platform 300. By comparing some or all of the new customer's profile data to the profile data of already-existing customers (e.g., customers with weeks or months of customer utilization history data), the traffic classifier 340 identifies a most similar “customer group” for the customer. In one such implementation, a semantic similarity model is used to vectorize some or all of a customer's profile information into embeddings represented within a same latent space in which vector-to-vector separations correlates with semantic similarity between customer profiles. By computing a dot product or cosine similarity between the embedding representing the new customer profile and the embeddings representing other customer profiles, a most similar existing customer (or group of such customers) is identified. Then, the new customer is initially assigned to the same model pool as the existing customer that identified as most similar to the new customer.

Each time a customer submits a workload for processing to one of the model instances 304a-304f, the corresponding model instance reports workload metrics 341 to the intelligence layer 302. The workload metrics 341 indicate, for each workload processed, a customer ID, as well as an observed modality-specific token utilization for the workload (e.g., the number of input tokens processed of each different supported modality). In some cases, the workload metrics 341 additionally identify the types of tokens processed (e.g., input tokens, cached tokens, generated tokens) that are of each different modality within each workload. Over time, as more and more workloads a processed by the MaaS platform 300 on behalf of the same customer, the workload metrics 341 are tracked and aggregated for the customer within the customer utilization history data 328. For example, the customer utilization history data 328 includes time series distributions of actual token count utilization for different types of tokens and different token modalities. In some implementations, each different time series distribution is specific to a different modality and/or token type.

Once the customer utilization history data 328 for a given customer includes data collected for a sufficient interval of predefined length (e.g., a few weeks), a modality-specific workload forecaster 330 uses the customer utilization history data 328 to generate a modality-specific workload prediction that predicts quantities of tokens of each different modality that the customer is likely to use across a future period of time. This prediction is described elsewhere herein as the “modality-specific workload prediction.” For example, the past three weeks of customer processing requests directed to the multimodal model are used to predict the customer's modality-specific token utilization over the next one week. This same prediction may be repeated multiple times throughout the future period of time (“the prediction interval”) to ensure that the prediction used to facilitate dynamic resource reblancing at any given instance is based on the most recent data available and thus, most likely to be representative of true demand. In one implementation, this prediction includes the same types of information as the modality-specific workload predictions discussed elsewhere herein.

In the intelligence layer 302, modality-specific workload forecaster 330 generates, for each new prediction interval, the modality-specific workload prediction for a plurality of customers assigned to the same model pool. For example, the modality-specific workload forecaster 330 generates the modality-specific workload prediction for a same time period and for all customers in each of the model pools 322, 324, 326 that have accrued a sufficient quantity of customer utilization history data 328 to render the corresponding predictions.

In FIG. 3, the intelligence layer 302 is shown to include an outlier detector 342 that receives the modality-specific workload predictions from the modality-specific workload forecaster 330. The outlier detector 342 analyzes the modality-specific workload predictions for the different customers to identify customers that are “outliers”—that is, customers that are predicted to experience an increase in token utilization of for a select data modality that exceeds a predefined threshold. This analysis entails, for example, a comparison of predicted token utilization for each modality relative to average utilizations of the customer over a recent time interval. Average token utilization for each modality is, for example, determined by accessing and analyzing customer utilization history data 328.

If, for example, the modality-specific workload prediction for a customer indicates that the customer's image token utilization is expected to double over the future time period relative to the customer's average image token utilization for the past three weeks, the customer may be flagged as an outlier. In this scenario, the customer's increase in image token utilization could-if large enough-increase latency in the image processing pipeline of the corresponding model instance and thereby “bottleneck” workload throughput through the model instance, impacting processing time of other workloads queued by other customers for processing by the same model instance. Although this increased latency in the image pipeline could potentially be reduced by adding processing resources to the image pipeline (as discussed with respect to FIG. 2), this allocation of additional resources may prove to be inefficient if there are no other customers in the same model pool experiencing the same trend of increased image token utilization relative to other types of tokens. In this case, the additional image processing resources allocated to the image pipeline would remain unused except when processing workloads for the single customer that is experiencing the increase image token utilization. Thus, instead of allocating additional processing resources to the image pipeline, the intelligence layer 302 enforces logic selectively re-assign “outlier customers” (e.g., customer with dramatically changing usage patterns) to different model pools. Specifically, a customer that is flagged as an outlier may be reassigned to a model pool with a compute ensemble ratio that is a better match for the customer's new usage pattern. This improves resource utilization across the model pools, decreasing resource waste. Notably, the act of re-assigning a customer to a new model pool yields the most improvement in resource utilization when reserved exclusively for customers with predicted data usage patterns that represent true “outliers”—that is, usage patterns that deviate from the usage patterns of other users in the same model pool by a significant (predefined) margin.

In one implementation, the outlier detector 342 flags a customer as an “outlier” (a candidate for reassignment to a new model pool) when it is determined that the customer's predicted token ensemble ratio for one or more modalities represents a change in token usage that exceeds a threshold rate of change. If, for example, the customer's predicted image token usage increases by more than a threshold amount, the customer is flagged as an outlier.

The traffic classifier 340 receives from the outlier detector 342, customer IDs and modality-specific workload predictions for customers identified as outliers. The traffic classifier 340 derives, from the modality-specific workload prediction that is generated for each customer, a predicted token ensemble ratio for that customer. The “predicted token ensemble ratio” is representative of the customer's predicted modality-specific token utilization over the same future time interval of the modality-specific workload prediction.

Using the predicted token ensemble ratios, the traffic classifier 340 performs reclassification actions to selectively re-assign customers to new model pools. In one implementation, these reclassification actions entail determining which of the model pools has a corresponding compute ensemble ratio that is most similar to the predicted token ensemble ratio of a given customer. Example reclassification actions are discussed with respect to FIG. 4, below.

In one implementations, the traffic classifier 340 performs the reclassification for customers identified as being “outliers,” as described above. The traffic classifier 340 may also perform the reclassification actions in other scenarios, such as to selectively divert high-usage customers away from model pools experiencing high utilization (e.g., greater than 95% utilization across all modality-specific pipelines). An example of this type of scenario is discussed below and based on latency predictions.

Like the intelligence layer described above with respect to FIG. 2, the intelligence layer 302 includes a modality-specific latency predictor 344 that uses the modality-specific workload predictions generated by the modality-specific workload forecaster 330 to predict, for each customer in each model pool, a modality-specific latency prediction for a future time interval. The modality-specific latency predictor 344 identifies a predicted latency that is expected to be observed within each of the modality-specific pipelines of the customer's assigned model instance while the model instance is processing data on behalf of the customer over the future time interval. From the latency values predicted across all customers and all modality-specific pipelines within a model pool (e.g., the model pool 322), the modality-specific latency predictor 344 determines a maximum latency that is predicted for each modality-specific processing pipeline.

If the predicted latency for one or more of the modality-specific processing pipelines exceeds a threshold (causes a “latency overage”), the modality-specific latency predictor 344 directs the resource allocation component 346 to attempt to identify a re-allocation of surplus resources within the customer's assigned model pool that can be used to alert the compute ensemble ratio of the model pool in a manner that eliminates the latency overage.

In response to receiving the above-described resource allocation request, the resource allocation component 346 evaluates the size of the predicted latency overage(s) and the location(s) of the predicated latency overages (e.g., the corresponding model. instances and processing pipeline). The resource allocation component 346 identifies a subset of additional processing resources sufficient to eliminate the latency overage, such as per the operations discussed with respect to FIG. 2. Then, the resource allocation component 346 determines the quantities and locations of “surplus” processing resources that are currently allocated to the customer's assigned model pool that are not predicted to be utilized during the future time interval. This identification of surplus resources is based on the maximum predicted latency determined for each modality-specific processing pipeline of each model instance and may be performed according to the operations described with respect to FIG. 2.

The resource allocation component 346 further determines whether it is possible to re-distribute the identified surplus resources within the customer's assigned model pool in a manner that eliminates the latency overage(s) and that also results in a resource re-allocation that is uniform within each individual model instance such that the resulting resource allocation is, for all of the model instances in the customer's assigned model pool, described by a same (new) compute ensemble ratio.

If, in the above-described scenario, the resource allocation component 346 determines that there exist insufficient surplus resources in the customer's assigned model pool to achieve a re-allocation of the surplus processing resources that both eliminates the latency overage(s) and results in a new compute ensemble ratio that is uniform for all of the model instances in the model pool, the resource allocation component 436 returns a “failure” response, which serves to indicate that inter-pool resource allocation is not feasible. In this scenario, the modality-specific latency predictor 344 may respond to the failure response by requesting that the customer be reassigned to a new model pool.

For example, the modality-specific latency predictor 344 identifies the customer ID of the customer that is predicted to cause the latency overages in one or more of the modality-specific processing pipelines of the customer's currently-assigned model pool and provides the customer ID and corresponding modality-specific workload prediction to the traffic classifier 340. Upon receiving this information, the traffic classifier 340 performs reclassification actions to reassign the customer to another model pool. Exemplary reclassification actions are discussed below with respect to FIG. 4.

FIG. 4 illustrates an example MaaS platform 400 that selectively assigns customers to model pools based on predicted token ensemble ratios and compute ensemble ratios that describe the allocation of resources within each different model pool. The MaaS platform 400 is shown to include three model pools-model pool A, model pool B, and model pool C. Each of the model pools A, B, and C includes one or more instances of a multimodal model. This multimodal model is the same (e.g., same model identifier and version) across all instances and all of the model pools. Within each individual one of the model pools A, B, and C, each individual one of the multimodal model instances is instantiated within a hardware architecture that allocates a dedicated group of processing resource to support each different modality-specific processing pipelines in each model instance.

Within model pool A, the total compute power allocated to each modal instance is allocated among the different modality-specific pipelines (e.g., image pipeline, language pipeline, audio pipeline, video pipeline) of the model instance according to a distribution of compute power that is described by a first compute ensemble ratio 404. By referencing image key 415, this distribution can be understood as allocating X percent of the total compute power allocated to each model instance to language processing, another X percent to image processing, 3X percent to video processing, and X percent to audio processing.

Within model pool B, the total compute power allocated to each modal instance is allocated among the different modality-specific pipelines of the model instance according to a distribution of processing resources that is described by a first compute ensemble ratio 406. Within model pool C, the total compute power allocated to each modal instance is allocated among the different modality-specific pipelines of the model instance according to a distribution of processing resources that is described by a first compute ensemble ratio 408.

The MaaS platform 400 includes an intelligence layer (not shown) that may, in various implementations, include some or all of the components described with respect to the intelligence layers of FIG. 1-FIG. 3. The intelligence layer includes a traffic classifier 410 that assigns MaaS platform customers to model pools by comparing a most-recently predicted token ensemble ratio for each customer (as generally described with respect to FIG. 3) to the compute ensemble ratios 404, 406, and 408 of the model pools A, B, and C. Each customer is assigned (and periodically re-assigned) to a select one of the model pools A, B, and C that is determined to have a compute ensemble ratio that is most similar to the customer's predicted token ensemble ratio.

In FIG. 4, the traffic classifier 410 is shown receiving a re-classification request 412 that is from other software component within the intelligence layer. Each re-classification request specifies a customer ID (for a customer that is to be re-classified) and a modality-specific workload prediction that has been generated for that customer, such as according to the operations generally described with respect to FIG. 2. In one implementation, the customer ID identifies a customer that has been identified as an “outlier” due to a change in a predicted workload usage pattern that satisfies predefined criteria. For example, the modality-specific workload prediction of the customer is indicative of a sharp increase in token utilization for a select data modality that exceeds a threshold rate of change.

In another implementation, the customer ID identifies a customer that is currently assigned to a model pool predicted to experience higher-then-normal utilization (above a target utilization threshold) over the future time interval corresponding to the modality-specific workload prediction. Additionally, the intelligence layer has generated a modality-specific latency prediction for the customer (generated as described with respect to FIG. 2), and this modality-specific workload prediction indicates that the customer is likely to submit workloads large enough to increase latency in one or more of the modality-specific processing pipelines above maximum latency threshold. In either of these scenarios, the reclassification actions are performed in the same general manner, described below.

The traffic classifier 410 derives, from the modality-specific workload prediction that is generated for each customer, a predicted token ensemble ratio for that customer. In FIG. 4, the re-classification request 412 identifies a customer ID for customer X. Customer X has a predicted token ensemble ratio 414, which indicates a distribution of token utilization that is 4x as heavy in video tokens as than in image, audio, or language tokens.

In FIG. 4, it is assumed that Customer X is currently assigned to model pool A. The re-classification request 412 directs the traffic classifier 410 to identify a model pool with a compute ensemble ratio most similar to the predicted token ensemble ratio 414. Depending upon the nature of the re-classification request 412 and other parameters specified in the request (not shown), the traffic classifier 410 may or may not exclude model pool A from candidacy as “a destination pool” for the reclassification action. If, for example, model pool A is predicted to experience extremely high utilization (e.g., lots of customers are expected to submit heavy workloads) throughout the prediction interval, the goal of the re-classification request 412 may be to divert the customer from model pool A. In this case, the re-classification request 412 may include a parameter that instructs the traffic classifier 410 to exclude pool A as a candidate when selecting the “best match” model pool.

In other implementations, the objective of the re-classification request 412 is to assess whether there exists a model pool that is a better match for customer X, given changes in the customer's predicted token utilization that represent a significant deviation from the customer's previous token utilization. In this case, model pool A (e.g., the customer's current model pool) may be considered as a candidate to receive (e.g., retain) customer X at the conclusion of the reclassification actions.

During the reclassification actions, the traffic classifier 410 computes a value for a similarity metric with respect to each of multiple different pairs of distributions. Each of these pairs includes (1) the distribution described by the predicted token ensemble ratio of the select customer (the predicted token ensemble ratio 414) and (2) a distribution that is described by the compute ensemble ratio of one of the candidate model pools. With reference to the illustrated example, this analysis entails computing a similarity metric between the predicted token ensemble ratio 414 and the compute ensemble ratios 404, 406, and 408 (with some implementations excluding compute ensemble ratio 404 because it corresponds to the customer's current model pool).

This similarity metric may, in different implementations, be computed in different ways. Suitable approaches for quantifying similarity between distributions include, for example, a Chi-squared test, an F-test, a Z-test, the use of histograms or box plots (e.g., to measure surface area under the distribution curve), as well as other statistical methods known in the art, all of which are exemplary methods of computing the above-described similarity metric.

The traffic classifier 410 identifies which one of the values computed for the similarity metric is indicative of the greatest degree of similarity. In one implementation, the traffic classifier 410 ranks compute ensemble ratios 404, 406, 408 in order of decreasing similarity and then performs additional analysis to determine whether the model pool with the most similar (“best match”) compute ensemble ratio has the capacity to receive the workloads of Customer X without exceeding latency targets. Assume, for example, that model pool C is identified as the “best match” because the compute ensemble ratio 408 is more similar to the predicted token ensemble ratio 414 than the compute ensemble ratio 408 of any other candidate model pool. Following this determination, the traffic classifier 410 may communicate with a modality-specific latency predictor (not shown) to identify a predicted net utilization of the processing resources in model pool A throughout the future time interval. Deriving this predicted net utilization may, for example, entail aggregating the modality-specific workload predictions or the future interval and across all customer's currently assigned to model pool A. If this predicted net utilization of model pool A is higher than a maximum target utilization, the traffic classifier 410 may elect not to assign customer X to model pool A; instead, the traffic classifier 410 identifies a “next best” match model pool (e.g., with the next most similar compute ensemble ratio) and determines whether it has a net utilization below the maximum target utilization. This analysis repeats until a “next best” model pool is identified with a net utilization below the maximum target utilization. Performing the above-described reclassification actions facilitates closer adherence to latency targets and improved system-wide resource utilization.

At the conclusion of the reclassification actions for a given customer, the traffic classifier 410 provides the routing layer 407 with the customer ID for the customer along with the identity of the newly-assigned model pool. The routing layer 407 updates a routing table to include the received information. Consequently, the routing layer 407 directs each subsequent request that includes the customer ID to the newly-assigned model pool.

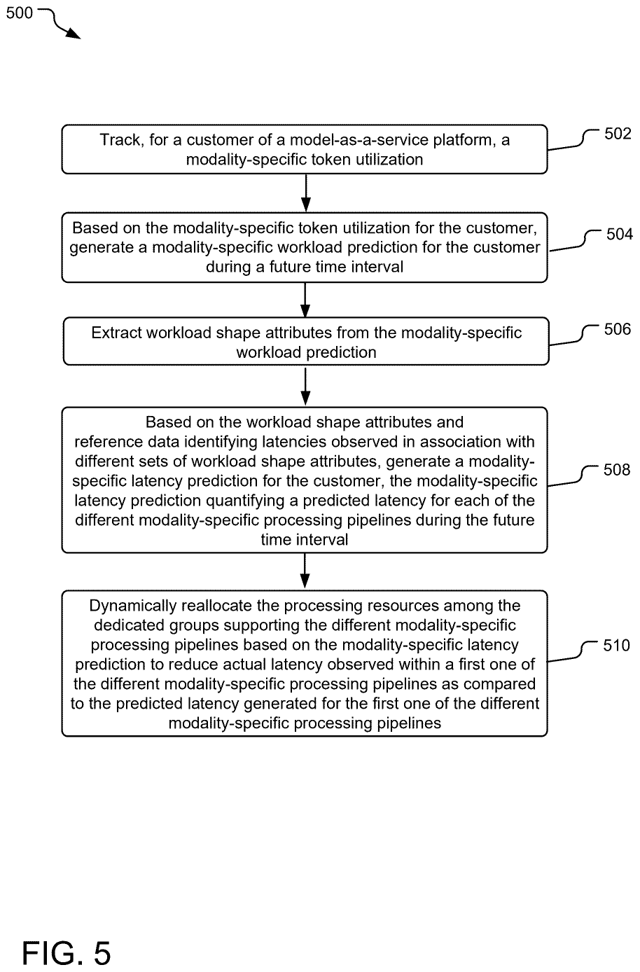

FIG. 5 illustrates example operations 500 for dynamically reallocating processing resources among dedicated groups that that respectively support different modality-specific processing pipelines of a multimodal model instance.

A tracking operation 502 tracks, for a customer of a model-as-a-service platform, a modality-specific token utilization over a period of time. For example, the tracked utilization data includes time series distributions that identify quantities of tokens, for each of multiple token modalities, that have been processed by a multimodal model instance on behalf of the customer.

A workload forecasting operation 504 uses the tracked utilization data to generate a modality-specific workload prediction for the customer that predicts token utilization over to future time interval. In one implementation, the modality-specific workload prediction includes a time series distributions that identify predicted token count utilization, over time, for different token modalities

A workload shape extraction operation 506 extracts workload shape attributes from the modality-specific workload prediction. For example, the workload shape attributes may include one or more configurable percentile values of the time series distributions included in the modality-specific workload prediction.

A latency prediction operation 508 generates a modality-specific latency prediction based on the extracted workload shape attributes and reference data that identifies latencies historically observed in association with different sets of workload shape attributes. The modality-specific latency prediction quantifies a predicted latency for each of the different modality-specific processing pipelines of the multimodal model instance during the future time interval.

A resource reallocation operation 510 dynamically reallocates the processing resources among the dedicated groups supporting the different modality-specific processing pipelines based on the modality-specific latency prediction. This dynamic reallocation is implemented in a manner that reduces actual latency observed within a first one of the different modality-specific processing pipelines as compared to the predicted latency of the different modality-specific processing pipelines.

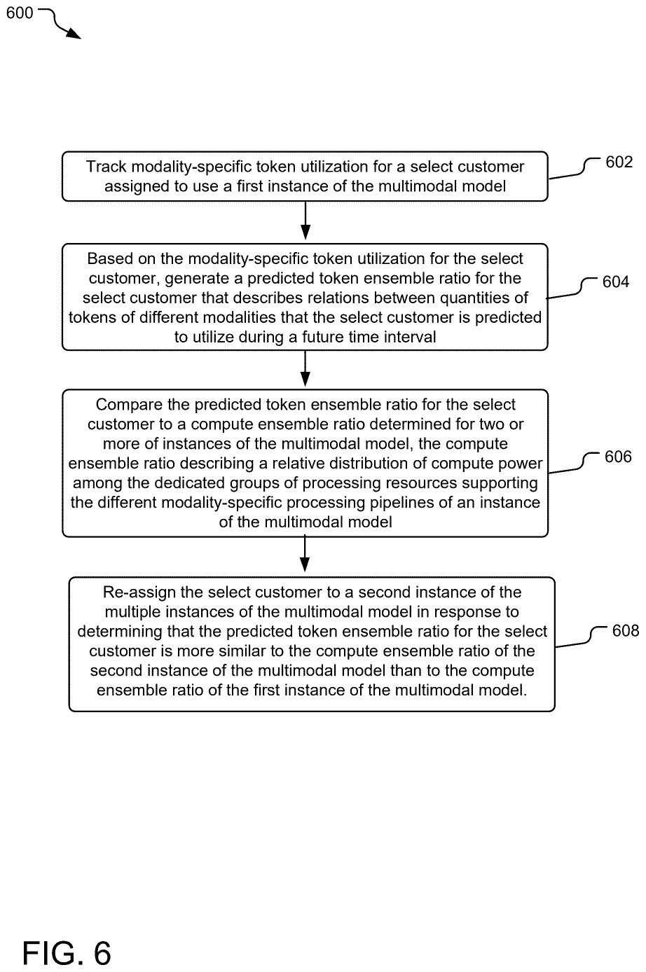

FIG. 6 illustrates example operations 600 for improving resource utilization within a MaaS platform that supports multiple instances of a multimodal model. In the MaaS platform, each of the multiple instances of the multimodal model is instantiated within a supporting hardware architecture that allocates dedicated groups of processing resources to support different modality-specific processing pipelines.

A tracking operation 602 tracks modality-specific token utilization for a select customer assigned to use a first instance of the multimodal model. A data analysis operation 604 generates a predicted token ensemble ratio for the select customer based on the modality-specific token utilization. The predicted token ensemble ratio for the select customer describes relations between quantities of tokens of different modalities that the customer is predicted to utilize during a future time interval.

A similarity assessment operation 606 compares the predicted token ensemble ratio that is generated for the select customer to a compute ensemble ratio determined for each of two or more of the multiple instances of the multimodal model. Each compute ensemble ratio describes a relative distribution of compute power among the dedicated groups of processing resources supporting the different modality-specific processing pipelines of an instance of the multimodal model.

A customer assignment operation 608 re-assigns the select customer to a second instance of the multimodal model in response to determining that the predicted token ensemble ratio is more similar to the compute ratio of the second instance of the multimodal model than to the compute ensemble ratio of the first instance of the multimodal model.

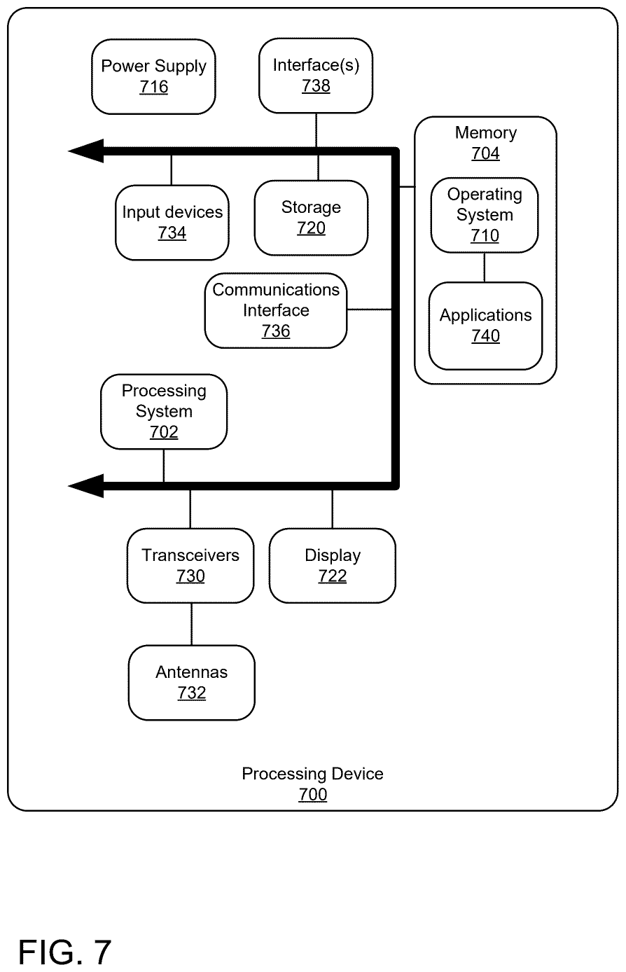

FIG. 7 illustrates an example schematic of a processing device 700 suitable for implementing aspects of the disclosed technology. The processing device 700 includes one or more processor unit(s) 702, memory device(s) 704, a display 706, and other interfaces 708 (e.g., buttons). The processor unit(s) 702 may each include one or more CPUs, GPUs, etc.

The memory device(s) 704 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, resides in the memory device(s) 704 and is executable by the processor unit(s) 702, although it should be understood that other operating systems may be employed.

One or more applications 712 (e.g., the multimodal model instance 104, the intelligence layer 102, or the resource allocation component 156) are loaded in the memory device(s) 704 and executed on the operating system 710 by the processor unit(s) 702. In some implementations, one o or more of the applications are distributed applications loaded into memory of multiple different processing devices connected across a network.

The applications 712 may receive inputs from one another as well as from various input local devices such as a microphone 734, input accessory 735 (e.g., keypad, mouse, stylus, touchpad, gamepad, racing wheel, joystick), and a camera 732. Additionally, the applications 712 may receive input from one or more remote devices, such as remotely-located smart devices, by communicating with such devices over a wired or wireless network using more communication transceivers 730 and an antenna 738 to provide network connectivity (e.g., a mobile phone network, Wi-Fi®, Bluetooth®). The processing device 700 may also include one or more storage devices 728 (e.g., non-volatile storage). Other configurations may also be employed.

The processing device 700 further includes a power supply 716, which is powered by one or more batteries or other power sources and which provides power to other components of the processing device 700. The power supply 716 may also be connected to an external power source (not shown) that overrides or recharges the built-in batteries or other power sources.

The processing device 700 may include a variety of tangible computer-readable storage media and intangible computer-readable communication signals. Tangible computer-readable storage can be embodied by any available media that can be accessed by the processing device 700 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared and other wireless media.

In some aspects, the techniques described herein relate to a model-as-a-service (MaaS) platform provided by a cloud management service, the MaaS platform including: a multimodal model instance instantiated within a hardware architecture that allocates dedicated groups of processing resources to modality-specific processing pipelines that supports token processing for a select one of multiple modalities supported by the multimodal model instance; and an intelligence layer stored in memory that: tracks a modality-specific token utilization over time; and based on the modality-specific token utilization, generates a modality-specific workload prediction for the multimodal model instance during a future time interval, the modality-specific workload prediction including modality-specific time series distributions of predicted token count utilization; generates a modality-specific latency prediction for the future time interval based on the modality-specific workload prediction, the modality-specific latency prediction quantifying a predicted latency for each of the modality-specific processing pipelines; and a resource allocation component stored in memory that performs a dynamic reallocation of the processing resources among the dedicated groups of processing resources supporting the modality-specific processing pipelines based on the modality-specific latency prediction.

In some aspects, the techniques described herein relate to a MaaS platform, wherein the dynamic reallocation allocates resources to a first one of the dedicated groups supporting processing for a first one of the modality-specific processing pipelines, and the dynamic reallocation is performed in response to determining that the modality-specific workload prediction identifies a predicted latency for the first one of the modality-specific processing pipelines in excess of a threshold.

In some aspects, the techniques described herein relate to a MaaS platform, wherein a different instance of the modality-specific workload prediction and the modality-specific latency prediction is generated for each of multiple customers using the multimodal model instance over the future time interval, and wherein the dynamic reallocation is performed in response to determining that, for each one of the multiple customers, the predicted latency for a second modality-specific processing pipeline is below a threshold during the future time interval, and wherein the dynamic reallocation removes the resources from a second one of the dedicated groups supporting processing for the second one of the modality-specific processing pipelines before adding the resources to the first one of the dedicated groups supporting processing for the first one of the modality-specific processing pipelines.

In some aspects, the techniques described herein relate to a MaaS platform, wherein the intelligence layer is further configured to: determine workload shape attributes for each of the modality-specific time series distributions of predicted token count utilization; provide the workload shape attributes as input to a latency prediction model trained on labeled data that identifies latency values measured in association with sets of the workload shape attributes for different modality-specific time series distributions of predicted token count utilization; receiving as output from the latency prediction model the modality-specific latency prediction.

In some aspects, the techniques described herein relate to a MaaS platform, wherein the modality-specific time series distributions of predicted token utilization each correspond to a specific token type selected from a group including: generated tokens, input tokens, and cached tokens.

In some aspects, the techniques described herein relate to a MaaS platform, wherein the workload shape attributes include a configurable percentile value determined for one or more of the modality-specific time series distributions.

In some aspects, the techniques described herein relate to a MaaS platform, wherein a first distribution of the modality-specific time series distributions predicts numbers of tokens generated by the multimodal model instance across fixed increments of the future time interval and wherein the configurable percentile value is determined for the first distribution.

In some aspects, the techniques described herein relate to a method for dynamically reallocating processing resources among dedicated groups that respectively support different modality-specific processing pipelines of a multimodal model instance, the method including: tracking, for a customer, a modality-specific token utilization of the multimodal model instance; based on the modality-specific token utilization for the customer, generating a modality-specific workload prediction for the customer during a future time interval; extracting workload shape attributes from the modality-specific workload prediction; based on the workload shape attributes and reference data identifying latencies observed in association with different sets of workload shape attributes, generating a modality-specific latency prediction for the customer, the modality-specific latency prediction quantifying a predicted latency for each of the different modality-specific processing pipelines during the future time interval; and creating a new resource distribution by dynamically reallocating the processing resources among the dedicated groups supporting the different modality-specific processing pipelines of the multimodal model instance based on the modality-specific latency prediction, wherein the new resource distribution reduces actual latency observed within a first one of the different modality-specific processing pipelines as compared to the predicted latency of the first one of the different modality-specific processing pipelines; and reducing customer-observed latencies by directing customer data received during the future time interval along the different modality-specific processing pipelines supported by the processing resources arranged according to the new resource distribution.

In some aspects, the techniques described herein relate to a method, further including: tracking the modality-specific token utilization of multiple customers over the future time interval; and generating a different instance of the modality-specific workload prediction and the modality-specific latency prediction for each of the multiple customers and the future time interval; dynamically reallocating the processing resources to a first one of the dedicated groups supporting the first one of the different modality-specific processing pipelines in response to determining that the predicted latency for the first one of the different modality-specific processing pipelines exceeds a threshold for at least one of the multiple customers.

In some aspects, the techniques described herein relate to a method, wherein dynamic reallocating includes: determining that the predicted latency for a second one of the different modality-specific processing pipelines is, for all of the multiple customers, below the threshold; and removing processing resources from a second one of the dedicated groups supporting processing tasks of the second one of the different modality-specific processing pipelines and adding the processing resources to a first one of the dedicated groups supporting processing tasks of the first one of the different modality-specific processing pipelines.

In some aspects, the techniques described herein relate to a method, wherein generating the modality-specific latency prediction further includes: providing the workload shape attributes as input to a latency prediction model trained on the reference data; receiving as output from the latency prediction model the modality-specific latency prediction.

In some aspects, the techniques described herein relate to a method, wherein the modality-specific workload prediction for the customer includes a plurality of modality-specific time series distributions, each distribution of the plurality of modality-specific time series distributions quantifying predicted token utilization for a corresponding modality of multiple modalities supported by the multimodal model instance.

In some aspects, the techniques described herein relate to a method, wherein each distribution of the plurality of modality-specific time series distributions quantifies token utilization for a specific token type selected from a group including: generated tokens, input tokens, and cached tokens, and wherein and the reference data used to train the latency prediction model includes modality-specific time series distributions of predicted token count utilization corresponding to the specific token type.

In some aspects, the techniques described herein relate to a method, wherein the workload shape attributes include a configurable percentile value computed for each distribution of the plurality the modality-specific time series distributions.

In some aspects, the techniques described herein relate to a method, wherein the plurality of modality-specific time series distributions includes a first set of distributions, the first set of distributions including a time series distribution corresponding to each of the multiple modalities that quantifies predicted numbers of tokens generated by the multimodal model instance across the future time interval and wherein the workload shape attributes includes a configurable percentile value for each distribution of the first set of distributions.

In some aspects, the techniques described herein relate to one or more tangible computer-readable storage media encoding process-executable instructions for executing a computer process including: tracking actual modality-specific token utilization for a customer of a multimodal model instance provided within a modal-as-a-service platform, the multimodal model instance being instantiated with a hardware architecture that allocates dedicated groups of processing resources to support different modality-specific processing pipelines of the multimodal model instance; generating modality-specific workload predictions for the customer over a future time interval based on the actual modality-specific token utilization; based on workload shape attributes extracted from the modality-specific workload predictions, generating a modality-specific latency prediction for the customer during the future time interval, the modality-specific latency prediction identifying a first predicted latency for a first one of the different modality-specific processing pipelines; and in response to determining that the first predicted latency exceeds a threshold, creating a new resource distribution by dynamically reallocating processing resources among the dedicated groups supporting the different modality-specific processing pipelines; reducing actual latency that is observed within the first one of the different modality-specific processing pipelines during processing performed for the customer as compared to the first predicted latency by directing directing data of the customer received during the future time interval along the different modality-specific processing pipelines supported by the processing resources arranged according to the new resource distribution.

In some aspects, the techniques described herein relate to one or more tangible computer-readable storage media, wherein a different instance of the modality-specific workload prediction and the modality-specific latency prediction is generated for each of multiple customers using the multimodal model instance over the future time interval, and wherein the processing resources are dynamically reallocated in response to determining that, for each one of the multiple customers, the predicted latency for a second modality-specific processing pipeline is below a threshold during the future time interval, and wherein dynamically reallocating the processing resources includes removing the resources from a second one of the dedicated groups supporting processing for the second one of the modality-specific processing pipelines before adding the resources to the first one of the dedicated groups supporting processing for the first one of the modality-specific processing pipelines.

In some aspects, the techniques described herein relate to one or more tangible computer-readable storage media, wherein the modality-specific workload predictions include modality-specific time series distributions of predicted token utilization for the customer and the computer process further includes: determining workload shape attributes for each of the modality-specific time series distributions of predicted token utilization, wherein the modality-specific latency prediction is based on the workload shape attributes.

In some aspects, the techniques described herein relate to one or more tangible computer-readable storage media, wherein the computer process further includes: providing the workload shape attributes as input to a latency prediction model trained on labeled data that identifies latency values measured in association with sets of the workload shape attributes for different modality-specific time series distributions of predicted token count utilization; and receiving as output from the latency prediction model the modality-specific latency prediction.

In some aspects, the techniques described herein relate to one or more tangible computer-readable storage media, wherein the modality-specific time series distributions of predicted token utilization each correspond to a specific token type selected from a group including: generated tokens, input tokens, and cached tokens and wherein the workload shape attributes include a configurable percentile value determined for each of the modality-specific time series distributions.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

1. A model-as-a-service (MaaS) platform provided by a cloud management service, the MaaS platform including:
a multimodal model instance instantiated within a hardware architecture that allocates dedicated groups of processing resources to modality-specific processing pipelines that supports token processing for a select one of multiple modalities supported by the multimodal model instance; and
an intelligence layer stored in memory that:
tracks a modality-specific token utilization over time; and
based on the modality-specific token utilization, generates a modality-specific workload prediction for the multimodal model instance during a future time interval, the modality-specific workload prediction including modality-specific time series distributions of predicted token count utilization;
generates a modality-specific latency prediction for the future time interval based on the modality-specific workload prediction, the modality-specific latency prediction quantifying a predicted latency for each of the modality-specific processing pipelines; and
a resource allocation component stored in memory that performs a dynamic reallocation of the processing resources among the dedicated groups of processing resources supporting the modality-specific processing pipelines based on the modality-specific latency prediction.

2. The MaaS platform of claim 1, wherein the dynamic reallocation allocates resources to a first one of the dedicated groups supporting processing for a first one of the modality-specific processing pipelines, and the dynamic reallocation is performed in response to determining that the modality-specific workload prediction identifies a predicted latency for the first one of the modality-specific processing pipelines in excess of a threshold.

3. The MaaS platform of claim 2, wherein a different instance of the modality-specific workload prediction and the modality-specific latency prediction is generated for each of multiple customers using the multimodal model instance over the future time interval, and
wherein the dynamic reallocation is performed in response to determining that, for each one of the multiple customers, the predicted latency for a second modality-specific processing pipeline is below a threshold during the future time interval, and
wherein the dynamic reallocation removes the resources from a second one of the dedicated groups supporting processing for the second one of the modality-specific processing pipelines before adding the resources to the first one of the dedicated groups supporting processing for the first one of the modality-specific processing pipelines.

4. The MaaS platform of claim 1, wherein the intelligence layer is further configured to:
determine workload shape attributes for each of the modality-specific time series distributions of predicted token count utilization;
provide the workload shape attributes as input to a latency prediction model trained on labeled data that identifies latency values measured in association with sets of the workload shape attributes for different modality-specific time series distributions of predicted token count utilization;
receiving as output from the latency prediction model the modality-specific latency prediction.

5. The MaaS platform of claim 4, wherein the modality-specific time series distributions of predicted token utilization each correspond to a specific token type selected from a group comprising: generated tokens, input tokens, and cached tokens.

6. The MaaS platform of claim 5, wherein the workload shape attributes include a configurable percentile value determined for one or more of the modality-specific time series distributions.

7. The MaaS platform of claim 6, wherein a first distribution of the modality-specific time series distributions predicts numbers of tokens generated by the multimodal model instance across fixed increments of the future time interval and wherein the configurable percentile value is determined for the first distribution.

8. A method for dynamically reallocating processing resources among dedicated groups that respectively support different modality-specific processing pipelines of a multimodal model instance, the method comprising:
tracking, for a customer, a modality-specific token utilization of the multimodal model instance;
based on the modality-specific token utilization for the customer, generating a modality-specific workload prediction for the customer during a future time interval;
extracting workload shape attributes from the modality-specific workload prediction;
based on the workload shape attributes and reference data identifying latencies observed in association with different sets of workload shape attributes, generating a modality-specific latency prediction for the customer, the modality-specific latency prediction quantifying a predicted latency for each of the different modality-specific processing pipelines during the future time interval; and
creating a new resource distribution by dynamically reallocating the processing resources among the dedicated groups supporting the different modality-specific processing pipelines of the multimodal model instance based on the modality-specific latency prediction, wherein the new resource distribution reduces actual latency observed within a first one of the different modality-specific processing pipelines as compared to the predicted latency of the first one of the different modality-specific processing pipelines; and
reducing customer-observed latencies by directing customer data received during the future time interval along the different modality-specific processing pipelines supported by the processing resources arranged according to the new resource distribution.

9. The method of claim 8, further comprising:
tracking the modality-specific token utilization of multiple customers over the future time interval; and
generating a different instance of the modality-specific workload prediction and the modality-specific latency prediction for each of the multiple customers and the future time interval;
dynamically reallocating the processing resources to a first one of the dedicated groups supporting the first one of the different modality-specific processing pipelines in response to determining that the predicted latency for the first one of the different modality-specific processing pipelines exceeds a threshold for at least one of the multiple customers.

10. The method of claim 9, wherein dynamic reallocating includes:
determining that the predicted latency for a second one of the different modality-specific processing pipelines is, for all of the multiple customers, below the threshold; and
removing processing resources from a second one of the dedicated groups supporting processing tasks of the second one of the different modality-specific processing pipelines and adding the processing resources to a first one of the dedicated groups supporting processing tasks of the first one of the different modality-specific processing pipelines.

11. The method of claim 8, wherein generating the modality-specific latency prediction further comprises:
providing the workload shape attributes as input to a latency prediction model trained on the reference data;
receiving as output from the latency prediction model the modality-specific latency prediction.

12. The method of claim 11, wherein the modality-specific workload prediction for the customer includes a plurality of modality-specific time series distributions, each distribution of the plurality of modality-specific time series distributions quantifying predicted token utilization for a corresponding modality of multiple modalities supported by the multimodal model instance.

13. The method of claim 12, wherein each distribution of the plurality of modality-specific time series distributions quantifies token utilization for a specific token type selected from a group comprising: generated tokens, input tokens, and cached tokens, and wherein and the reference data used to train the latency prediction model includes modality-specific time series distributions of predicted token count utilization corresponding to the specific token type.

14. The method of claim 12, wherein the workload shape attributes include a configurable percentile value computed for each distribution of the plurality the modality-specific time series distributions.

15. The method of claim 14, wherein the plurality of modality-specific time series distributions includes a first set of distributions, the first set of distributions including a time series distribution corresponding to each of the multiple modalities that quantifies predicted numbers of tokens generated by the multimodal model instance across the future time interval and wherein the workload shape attributes includes a configurable percentile value for each distribution of the first set of distributions.

16. One or more tangible computer-readable storage media encoding process-executable instructions for executing a computer process comprising:
tracking actual modality-specific token utilization for a customer of a multimodal model instance provided within a modal-as-a-service platform, the multimodal model instance being instantiated with a hardware architecture that allocates dedicated groups of processing resources to support different modality-specific processing pipelines of the multimodal model instance;
generating modality-specific workload predictions for the customer over a future time interval based on the actual modality-specific token utilization;
based on workload shape attributes extracted from the modality-specific workload predictions, generating a modality-specific latency prediction for the customer during the future time interval, the modality-specific latency prediction identifying a first predicted latency for a first one of the different modality-specific processing pipelines; and
in response to determining that the first predicted latency exceeds a threshold, creating a new resource distribution by dynamically reallocating processing resources among the dedicated groups supporting the different modality-specific processing pipelines;
reducing actual latency that is observed within the first one of the different modality-specific processing pipelines during processing performed for the customer as compared to the first predicted latency by directing directing data of the customer received during the future time interval along the different modality-specific processing pipelines supported by the processing resources arranged according to the new resource distribution.

17. The one or more tangible computer-readable storage media of claim 16, wherein a different instance of the modality-specific workload prediction and the modality-specific latency prediction is generated for each of multiple customers using the multimodal model instance over the future time interval, and
wherein the processing resources are dynamically reallocated in response to determining that, for each one of the multiple customers, the predicted latency for a second modality-specific processing pipeline is below a threshold during the future time interval, and
wherein dynamically reallocating the processing resources includes removing the resources from a second one of the dedicated groups supporting processing for the second one of the modality-specific processing pipelines before adding the resources to the first one of the dedicated groups supporting processing for the first one of the modality-specific processing pipelines.

18. The one or more tangible computer-readable storage media of claim 16, wherein the modality-specific workload predictions include modality-specific time series distributions of predicted token utilization for the customer and the computer process further comprises:
determining workload shape attributes for each of the modality-specific time series distributions of predicted token utilization, wherein the modality-specific latency prediction is based on the workload shape attributes.

19. The one or more tangible computer-readable storage media of claim 17, wherein the computer process further comprises:
providing the workload shape attributes as input to a latency prediction model trained on labeled data that identifies latency values measured in association with sets of the workload shape attributes for different modality-specific time series distributions of predicted token count utilization; and
receiving as output from the latency prediction model the modality-specific latency prediction.

20. The one or more tangible computer-readable storage media of claim 16, wherein the modality-specific time series distributions of predicted token utilization each correspond to a specific token type selected from a group comprising: generated tokens, input tokens, and cached tokens and wherein the workload shape attributes include a configurable percentile value determined for each of the modality-specific time series distributions.
